(19) United States
(12) Patent Application Publication
(10) Pub. No.: US 2025/0028785 A1
(43) Pub. Date: Jan. 23, 2025

(54) Reconfigurable Processing Element for a Systolic Array

(71) Applicant: SambaNova Systems, Inc., Palo Alto, CA (US)

(72) Inventors: Mark William Gottscho, Mountain View, CA (US); Nasim Farahini, Täby (SE); Raghu PRABHAKAR, San Jose, CA (US); Hakan Zeffer, Enskede (SE)

(73) Assignee: SambaNova Systems, Inc., Palo Alto, CA (US)

(21) Appl. No.: 18/779,442

(22) Filed: Jul. 22, 2024

Related U.S. Application Data
(60) Provisional application No. 63/527,952, filed on Jul. 20, 2023.

(51) Int. Cl. G06F 17/16; G06F 15/80

(52) U.S. Cl. CPC G06F 17/16; G06F 15/8046

(57) ABSTRACT

A reconfigurable processing element for a systolic array that is configurable for multiplying a first matrix with a second matrix to determine a result matrix in a weight stationary mode or in an output stationary mode is presented. Furthermore, a systolic array for performing matrix multiplication of a first matrix and a second matrix to determine a result matrix is presented that includes a plurality of reconfigurable processing elements that are configurable for operating in a weight stationary mode or in an output stationary mode. Moreover, a method of operating a reconfigurable processing element for a systolic array that is configured for performing matrix multiplication of a first matrix and a second matrix to determine a result matrix in a weight stationary mode or in an output stationary mode is presented.

### RELATED APPLICATIONS AND DOCUMENTS

This application claims the benefit of U.S. Provisional Patent Application No. 63/527,952, entitled, “Block Sparse Format Data Path” filed on 20 Jul. 2023. The provisional application is hereby incorporated by reference for all purposes.

This application is related to the following papers and commonly owned applications:
Prabhakar et al., “Plasticine: A Reconfigurable Architecture for Parallel Patterns,” ISCA '17, Jun. 24-28, 2017, Toronto, ON, Canada;
Koeplinger et al., “Spatial: A Language And Compiler For Application Accelerators,” Proceedings Of The 39th ACM SIGPLAN Conference On Programming Language Design And Embodiment (PLDI), Proceedings of the 43rd International Symposium on Computer Architecture, 2018;
U.S. Nonprovisional patent application Ser. No. 16/239,252, now U.S. Pat. No. 10,698,853 B1, filed Jan. 3, 2019, entitled “VIRTUALIZATION OF A RECONFIGURABLE DATA PROCESSOR;”
U.S. Nonprovisional patent application Ser. No. 16/862,445, now U.S. Pat. No. 11,188,497 B2, filed Nov. 21, 2018, entitled “CONFIGURATION UNLOAD OF A RECONFIGURABLE DATA PROCESSOR;”
U.S. Nonprovisional patent application Ser. No. 16/197,826, now U.S. Pat. No. 10,831,507 B2, filed Nov. 21, 2018, entitled “CONFIGURATION LOAD OF A RECONFIGURABLE DATA PROCESSOR;”
U.S. Nonprovisional patent application Ser. No. 16/198,086, now U.S. Pat. No. 11,188,497 B2, filed Nov. 21, 2018, entitled “CONFIGURATION UNLOAD OF A RECONFIGURABLE DATA PROCESSOR;”
U.S. Nonprovisional patent application Ser. No. 17/093,543, filed Nov. 9, 2020, entitled “EFFICIENT CONFIGURATION OF A RECONFIGURABLE DATA PROCESSOR;”
U.S. Nonprovisional patent application Ser. No. 16/260,548, now U.S. Pat. No. 10,768,899 B2, filed Jan. 29, 2019, entitled “MATRIX NORMAL/TRANSPOSE READ AND A RECONFIGURABLE DATA PROCESSOR INCLUDING SAME;”
U.S. Nonprovisional patent application Ser. No. 16/536,192, now U.S. Pat. No. 11,080,227 B2, filed Aug. 8, 2019, entitled “COMPILER FLOW LOGIC FOR RECONFIGURABLE ARCHITECTURES;”
U.S. Nonprovisional patent application Ser. No. 17/326,128, filed May 20, 2021, entitled “COMPILER FLOW LOGIC FOR RECONFIGURABLE ARCHITECTURES;”
U.S. Nonprovisional patent application Ser. No. 16/407,675, now U.S. Pat. No. 11,386,038 B2, filed May 9, 2019, entitled “CONTROL FLOW BARRIER AND RECONFIGURABLE DATA PROCESSOR;”
U.S. Nonprovisional patent application Ser. No. 16/504,627, now U.S. Pat. No. 11,055,141 B2, filed Jul. 8, 2019, entitled “QUIESCE RECONFIGURABLE DATA PROCESSOR;”
U.S. Nonprovisional patent application Ser. No. 17/322,697, filed May 17, 2021, entitled “QUIESCE RECONFIGURABLE DATA PROCESSOR;”
U.S. Nonprovisional patent application Ser. No. 16/572,516, filed Sep. 16, 2019, entitled “EFFICIENT EXECUTION OF OPERATION UNIT GRAPHS ON RECONFIGURABLE ARCHITECTURES BASED ON USER SPECIFICATION;”
U.S. Nonprovisional patent application Ser. No. 16/744,077, filed Jan. 15, 2020, entitled “COMPUTATIONALLY EFFICIENT SOFTMAX LOSS GRADIENT BACKPROPAGATION;”
U.S. Nonprovisional patent application Ser. No. 16/590,058, now U.S. Pat. No. 11,327,713 B2, filed Oct. 1, 2019, entitled “COMPUTATION UNITS FOR FUNCTIONS BASED ON LOOKUP TABLES;”
U.S. Nonprovisional patent application Ser. No. 16/695,138, now U.S. Pat. No. 11,328,038 B2, filed Nov. 25, 2019, entitled “COMPUTATIONAL UNITS FOR BATCH NORMALIZATION;”
U.S. Nonprovisional patent application Ser. No. 16/688,069, filed Nov. 19, 2019, now U.S. Pat. No. 11,327,717 B2, entitled “LOOK-UP TABLE WITH INPUT OFFSETTING;”
U.S. Nonprovisional patent application Ser. No. 16/718,094, filed Dec. 17, 2019, now U.S. Pat. No. 11,150,872 B2, entitled “COMPUTATIONAL UNITS FOR ELEMENT APPROXIMATION;”
U.S. Nonprovisional patent application Ser. No. 16/560,057, now U.S. Pat. No. 11,327,923 B2, filed Sep. 4, 2019, entitled “SIGMOID FUNCTION IN HARDWARE AND A RECONFIGURABLE DATA PROCESSOR INCLUDING SAME;”
U.S. Nonprovisional patent application Ser. No. 16/572,527, now U.S. Pat. No. 11,410,027 B2, filed Sep. 16, 2019, entitled “Performance Estimation-Based Resource Allocation for Reconfigurable Architectures;”
U.S. Nonprovisional patent application Ser. No. 15/930,381, now U.S. Pat. No. 11,250,105 B2, filed May 12, 2020, entitled “COMPUTATIONALLY EFFICIENT GENERAL MATRIX-MATRIX MULTIPLICATION (GEMM);”
U.S. Nonprovisional patent application Ser. No. 17/337,080, now U.S. Pat. No. 11,328,209 B1, filed Jun. 2, 2021, entitled “MEMORY EFFICIENT DROPOUT;”
U.S. Nonprovisional patent application Ser. No. 17/337,126, now U.S. Pat. No. 11,256,987 B1, filed Jun. 2, 2021, entitled “MEMORY EFFICIENT DROPOUT, WITH REORDERING OF DROPOUT MASK ELEMENTS;”
U.S. Nonprovisional patent application Ser. No. 16/890,841, filed Jun. 2, 2020, entitled “ANTI-CONGESTION FLOW CONTROL FOR RECONFIGURABLE PROCESSORS;”
U.S. Nonprovisional patent application Ser. No. 17/023,015, now U.S. Pat. No. 11,237,971 B1, filed Sep. 16, 2020, entitled “COMPILE TIME LOGIC FOR DETECTING STREAMING COMPATIBLE AND BROADCAST COMPATIBLE DATA ACCESS PATTERNS;”
U.S. Nonprovisional patent application Ser. No. 17/031,679, filed Sep. 24, 2020, entitled “SYSTEMS AND METHODS FOR MEMORY LAYOUT DETERMINATION AND CONFLICT RESOLUTION;”
U.S. Nonprovisional patent application Ser. No. 17/175,289, now U.S. Pat. No. 11,126,574 B1, filed Feb. 12, 2021, entitled “INSTRUMENTATION PROFILING FOR RECONFIGURABLE PROCESSORS;”
U.S. Nonprovisional patent application Ser. No. 17/371,049, filed Jul. 8, 2021, entitled “SYSTEMS AND METHODS FOR EDITING TOPOLOGY OF A RECONFIGURABLE DATA PROCESSOR;”
U.S. Nonprovisional patent application Ser. No. 16/922,975, filed Jul. 7, 2020, entitled “RUNTIME VIRTUALIZATION OF RECONFIGURABLE DATA FLOW RESOURCES;”
U.S. Nonprovisional patent application Ser. No. 16/996,666, filed Aug. 18, 2020, entitled “RUNTIME PATCHING OF CONFIGURATION FILES;”
U.S. Nonprovisional patent application Ser. No. 17/214,768, now U.S. Pat. No. 11,200,096 B1, filed Mar. 26, 2021, entitled “RESOURCE ALLOCATION FOR RECONFIGURABLE PROCESSORS;”
U.S. Nonprovisional patent application Ser. No. 17/127,818, now U.S. Pat. No. 11,182,264 B1, filed Dec. 18, 2020, entitled “INTRA-NODE BUFFER-BASED STREAMING FOR RECONFIGURABLE PROCESSOR-AS-A-SERVICE (RPAAS);”
U.S. Nonprovisional patent application Ser. No. 17/127,929, now U.S. Pat. No. 11,182,221 B1, filed Dec. 18, 2020, entitled “INTER-NODE BUFFER-BASED STREAMING FOR RECONFIGURABLE PROCESSOR-AS-A-SERVICE (RPAAS);”
U.S. Nonprovisional patent application Ser. No. 17/185,264, filed Feb. 25, 2021, entitled “TIME-MULTIPLEXED USE OF RECONFIGURABLE HARDWARE;”
U.S. Nonprovisional patent application Ser. No. 17/216,647, now U.S. Pat. No. 11,204,889 B1, filed Mar. 29, 2021, entitled “TENSOR PARTITIONING AND PARTITION ACCESS ORDER;”
U.S. Nonprovisional patent application Ser. No. 17/216,650, now U.S. Pat. No. 11,366,783 B1, filed Mar. 29, 2021, entitled “MULTI-HEADED MULTI-BUFFER FOR BUFFERING DATA FOR PROCESSING;”
U.S. Nonprovisional patent application Ser. No. 17/216,657, now U.S. Pat. No. 11,263,170 B1, filed Mar. 29, 2021, entitled “LOSSLESS TILING IN CONVOLUTION NETWORKS-PADDING BEFORE TILING, LOCATION-BASED TILING, AND ZEROING-OUT;”
U.S. Nonprovisional patent application Ser. No. 17/384,515, filed Jul. 23, 2021, entitled “LOSSLESS TILING IN CONVOLUTION NETWORKS-MATERIALIZATION OF TENSORS;”
U.S. Nonprovisional patent application Ser. No. 17/216,651, now U.S. Pat. No. 11,195,080 B1, filed Mar. 29, 2021, entitled “LOSSLESS TILING IN CONVOLUTION NETWORKS-TILING CONFIGURATION;”
U.S. Nonprovisional patent application Ser. No. 17/216,652, now U.S. Pat. No. 11,227,207 B1, filed Mar. 29, 2021, entitled “LOSSLESS TILING IN CONVOLUTION NETWORKS-SECTION BOUNDARIES;”
U.S. Nonprovisional patent application Ser. No. 17/216,654, now U.S. Pat. No. 11,250,061 B1, filed Mar. 29, 2021, entitled “LOSSLESS TILING IN CONVOLUTION NETWORKS-READ-MODIFY-WRITE IN BACKWARD PASS;”
U.S. Nonprovisional patent application Ser. No. 17/216,655, now U.S. Pat. No. 11,232,360 B1, filed Mar. 29, 2021, entitled “LOSSLESS TILING IN CONVOLUTION NETWORKS-WEIGHT GRADIENT CALCULATION;”
U.S. Nonprovisional patent application Ser. No. 17/364,110, filed Jun. 30, 2021, entitled “LOSSLESS TILING IN CONVOLUTION NETWORKS-TILING CONFIGURATION FOR A SEQUENCE OF SECTIONS OF A GRAPH;”
U.S. Nonprovisional patent application Ser. No. 17/364,129, filed Jun. 30, 2021, entitled “LOSSLESS TILING IN CONVOLUTION NETWORKS-TILING CONFIGURATION BETWEEN TWO SECTIONS;”
“U.S. Nonprovisional patent application Ser. No. 17/364,141, filed Jun. 30, 2021, entitled ““LOSSLESS TILING IN CONVOLUTION NETWORKS-PADDING AND RE-TILLING AT SECTION BOUNDARIES;”
U.S. Nonprovisional patent application Ser. No. 17/384,507, filed Jul. 23, 2021, entitled “LOSSLESS TILING IN CONVOLUTION NETWORKS-BACKWARD PASS;”
U.S. Provisional Patent Application No. 63/107,413, filed Oct. 29, 2020, entitled “SCANNABLE LATCH ARRAY FOR STRUCTURAL TEST AND SILICON DEBUG VIA SCANDUMP;”
U.S. Provisional Patent Application No. 63/165,073, filed Mar. 23, 2021, entitled “FLOATING POINT MULTIPLY-ADD, ACCUMULATE UNIT WITH CARRY-SAVE ACCUMULATOR IN BF16 AND FLP32 FORMAT;”
U.S. Provisional Patent Application No. 63/166,221, filed Mar. 25, 2021, entitled “LEADING ZERO AND LEADING ONE DETECTOR PREDICTOR SUITABLE FOR CARRY-SAVE FORMAT;”
U.S. Provisional Patent Application No. 63/174,460, filed Apr. 13, 2021, entitled “EXCEPTION PROCESSING IN CARRY-SAVE ACCUMULATION UNIT FOR MACHINE LEARNING;”
U.S. Nonprovisional patent application Ser. No. 17/397,241, now U.S. Pat. No. 11,429,349 B1, filed Aug. 9, 2021, entitled “FLOATING POINT MULTIPLY-ADD, ACCUMULATE UNIT WITH CARRY-SAVE ACCUMULATOR;”
U.S. Nonprovisional patent application Ser. No. 17/216,509, now U.S. Pat. No. 11,191,182 B1, filed Mar. 29, 2021, entitled “UNIVERSAL RAIL KIT;”
U.S. Nonprovisional patent application Ser. No. 17/379,921, now U.S. Pat. No. 11,392,740 B2, filed Jul. 19, 2021, entitled “DATAFLOW FUNCTION OFFLOAD TO RECONFIGURABLE PROCESSORS;”
U.S. Nonprovisional patent application Ser. No. 17/379,924, now U.S. Pat. No. 11,237,880 B1, filed Jul. 19, 2021, entitled “DATAFLOW ALL-REDUCE FOR RECONFIGURABLE PROCESSOR SYSTEMS;”
U.S. Nonprovisional patent application Ser. No. 17/378,342, now U.S. Pat. No. 11,556,494 B1, filed Jul. 16, 2021, entitled “DEFECT REPAIR FOR A RECONFIGURABLE DATA PROCESSOR;”
U.S. Nonprovisional patent application Ser. No. 17/378,391, now U.S. Pat. No. 11,327,771 B1, filed Jul. 16, 2021, entitled “DEFECT REPAIR CIRCUITS FOR A RECONFIGURABLE DATA PROCESSOR;”
U.S. Nonprovisional patent application Ser. No. 17/378,399, now U.S. Pat. No. 11,409,540 B1, filed Jul. 16, 2021, entitled “ROUTING CIRCUITS FOR DEFECT REPAIR FOR A RECONFIGURABLE DATA PROCESSOR;”
U.S. Provisional Patent Application No. 63/220,266, filed Jul. 9, 2021, entitled “LOGIC BIST AND FUNCTIONAL TEST FOR A CGRA;”
U.S. Provisional Patent Application No. 63/195,664, filed Jun. 1, 2021, entitled “VARIATION-TOLERANT VARIABLE-LENGTH CLOCK-STRETCHER MODULE WITH IN-SITU END-OF-CHAIN DETECTION MECHANISM;”
U.S. Nonprovisional patent application Ser. No. 17/338,620, now U.S. Pat. No. 11,323,124 B1, filed Jun. 3, 2021, entitled “VARIABLE-LENGTH CLOCK STRETCHER WITH CORRECTION FOR GLITCHES DUE TO FINITE DLL BANDWIDTH;”
U.S. Nonprovisional patent application Ser. No. 17/338,625, now U.S. Pat. No. 11,239,846 B1, filed Jun. 3, 2021, entitled “VARIABLE-LENGTH CLOCK STRETCHER WITH CORRECTION FOR GLITCHES DUE TO PHASE DETECTOR OFFSET;”
U.S. Nonprovisional patent application Ser. No. 17/338,626, now U.S. Pat. No. 11,290,113 B1, filed Jun. 3, 2021, entitled “VARIABLE-LENGTH CLOCK STRETCHER WITH CORRECTION FOR DIGITAL DLL GLITCHES;”
U.S. Nonprovisional patent application Ser. No. 17/338,629, now U.S. Pat. No. 11,290,114 B1, filed Jun. 3, 2021, entitled “VARIABLE-LENGTH CLOCK STRETCHER WITH PASSIVE MODE JITTER REDUCTION;”
U.S. Nonprovisional patent application Ser. No. 17/405,913, now U.S. Pat. No. 11,334,109 B1, filed Aug. 18, 2021, entitled “VARIABLE-LENGTH CLOCK STRETCHER WITH COMBINER TIMING LOGIC;”
U.S. Provisional Patent Application No. 63/230,782, filed Aug. 8, 2021, entitled “LOW-LATENCY MASTER-SLAVE CLOCKED STORAGE ELEMENT;”
U.S. Provisional Patent Application No. 63/236,218, filed Aug. 23, 2021, entitled “SWITCH FOR A RECONFIGURABLE DATAFLOW PROCESSOR;”
U.S. Provisional Patent Application No. 63/236,214, filed Aug. 23, 2021, entitled “SPARSE MATRIX MULTIPLIER;”
U.S. Provisional Patent Application No. 63/389,767, filed Jul. 15, 2022. entitled “PEER-TO-PEER COMMUNICATION BETWEEN RECONFIGURABLE DATAFLOW UNITS;”
U.S. Provisional Patent Application No. 63/405,240, filed Sep. 9, 2022, entitled “PEER-TO-PEER ROUTE THROUGH IN A RECONFIGURABLE COMPUTING SYSTEM.”
   All of the related application(s) and documents listed above are hereby incorporated by reference herein for all purposes.

### FIELD OF THE TECHNOLOGY DISCLOSED

The present technology relates to a reconfigurable processing element for a systolic array, and more particularly, to a reconfigurable processing element for a systolic array that is configurable for multiplying a first matrix with a second matrix to determine a result matrix in a weight stationary mode or in an output stationary mode. Furthermore, the present technology relates to a systolic array for performing matrix multiplication of a first matrix and a second matrix to determine a result matrix. The systolic array includes a plurality of reconfigurable processing elements that are configurable for operating in a weight stationary mode or in an output stationary mode. Moreover, the present technology relates to a method of operating a reconfigurable processing element for a systolic array that is configured for performing matrix multiplication of a first matrix and a second matrix to determine a result matrix in a weight stationary mode or in an output stationary mode, wherein the reconfigurable processing element comprises first and second input ports, first and second multiplexer circuitry, an internal register, a multiplier circuit, and an adder circuit.

### BACKGROUND

The subject matter discussed in this section should not be assumed to be prior art merely as a result of its mention in this section. Similarly, a problem mentioned in this section or associated with the subject matter provided as background should not be assumed to have been previously recognized in the prior art. The subject matter in this section merely represents different approaches, which in and of themselves can also correspond to implementations of the claimed technology.

Deep learning is a subset of machine learning algorithms that are inspired by the structure and function of the human brain. Most deep learning algorithms involve artificial neural network architectures, in which multiple layers of neurons each receive input from neurons in a prior layer or layers, and in turn influence the neurons in the subsequent layer or layers. Training these neural network models can be computationally extremely demanding.

As machine learning based technologies are more widely deployed, it is becoming important to implement them at low cost using flexible hardware architectures. In such architectures, including integrated circuit components, area, and power consumption are critical design parameters. One class of integrated circuits includes reconfigurable processors.

Reconfigurable processors can be configured to implement a variety of functions. In particular, so-called Coarse-Grained Reconfigurable Architectures (CGRAs) are being developed in which the configurable units in the array are complex and that may enable faster or more efficient execution of various classes of functions. For example, CGRAs have been proposed that can enable implementation of energy-efficient accelerators for machine learning and artificial intelligence workloads. See, Prabhakar, et al., “Plasticine: A Reconfigurable Architecture for Parallel Patterns,” ISCA '17, Jun. 24-28, 2017, Toronto, ON, Canada. Various aspects of some of such CGRAs are described in the above-incorporated patent applications.

A CGRA typically includes an array of reconfigurable units and operate on streams of data and control messages that flow through a sea of these reconfigurable units, sometimes referred to herein as Coarse-Grained Reconfigurable Units (CGRUs). The units can comprise somewhat specialized computational and memory units.

The heart of deep learning is matrix multiplication. Thus, matrix multiplication is used in many applications for machine learning and artificial intelligence. Furthermore, matrix multiplication forms the basis for many computations in linear algebra because it is the core routine behind the Level-3 basic linear algebra subprograms (BLAS) and much of linear algebra package (LAPACK).

### BRIEF DESCRIPTION OF THE DRAWINGS

In the drawings, like reference characters generally refer to like parts throughout the different views. Also, the drawings are not necessarily to scale, with an emphasis instead generally being placed upon illustrating the principles of the technology disclosed. In the following description, various implementations of the technology disclosed are described with reference to the following drawings.

FIG. 1 is a diagram of an illustrative matrix multiplication of a first matrix with a second matrix to produce a result matrix.

FIG. 2 is a diagram of an illustrative reconfigurable processor that is configured to perform a matrix multiplication of the first matrix with the second matrix of FIG. 1 in an output stationary mode.

FIG. 3 is a diagram of an illustrative reconfigurable processor that is configured to perform a matrix multiplication of the first matrix with the second matrix of FIG. 1 in a weight stationary mode.

FIG. 4 is a diagram of an illustrative systolic array with a plurality of reconfigurable processing elements.

FIG. 5A is a diagram of an illustrative processing element operating in an output stationary mode.

FIG. 5B is a diagram of an illustrative processing element operating in a weight stationary mode.

FIG. 6 is a diagram of an illustrative reconfigurable processing element for a systolic array that is configurable for multiplying a first matrix with a second matrix to determine a result matrix in a weight stationary mode or in an output stationary mode.

FIG. 7A is a diagram of the illustrative reconfigurable processing element of FIG. 6 configured to operate in the output stationary mode.

FIG. 7B is a diagram of the illustrative reconfigurable processing element of FIG. 6 configured to operate in the weight stationary mode.

FIG. 8 is a flowchart showing illustrative operations that a reconfigurable processing element performs in a systolic array that is configured for performing matrix multiplication of a first matrix and a second matrix to determine a result matrix in a weight stationary mode or in an output stationary mode.

### DETAILED DESCRIPTION

The following discussion is presented to enable any person skilled in the art to make and use the technology disclosed and is provided in the context of a particular application and its requirements. Various modifications to the disclosed implementations will be readily apparent to those skilled in the art, and the general principles defined herein may be applied to other implementations and applications without departing from the spirit and scope of the technology disclosed. Thus, the technology disclosed is not intended to be limited to the implementations shown but is to be accorded the widest scope consistent with the principles and features disclosed herein.

Traditional compilers translate human-readable computer source code into machine code that can be executed on a Von Neumann computer architecture. In this architecture, a processor serially executes instructions in one or more threads of software code. The architecture is static and the compiler does not determine how execution of the instructions is pipelined, or which processor or memory takes care of which thread. Thread execution is asynchronous, and safe exchange of data between parallel threads is not supported.

Applications for machine learning (ML) and artificial intelligence (AI) may require massively parallel computations, where many parallel and interdependent threads (metapipelines) exchange data. Therefore, such applications are ill-suited for execution on Von Neumann computers.

Moreover, as mentioned above, matrix multiplication is used in many applications for machine learning and artificial intelligence and forms the basis for many computations in linear algebra. Matrix multiplication operations require architectures that are adapted for parallel processing,

Systolic arrays are an extremely attractive platform for performing matrix multiplication when performance, power, or energy efficiency are paramount. A systolic array has a parallel architecture, made out of relatively simple processors, that are regularly and locally connected. The data circulate through these processors in a synchronous manner and interact where they meet.

Traditionally, systolic arrays perform matrix multiplication either in an input stationary mode, which is sometimes also referred to as weight stationary mode or in an output stationary mode. However, depending on the dimensions of the matrices and depending on the architecture of the processing elements and the connectivity of the processing elements in the systolic array, operating in weight stationary mode may be more efficient than operating in output stationary mode or vice versa.

Coarse-grained reconfigurable architectures (CGRAs) may be configured to implement a systolic array for matrix multiplication. However, the processing units or processing elements in the CGRAs may only be configured to operate in either the output stationary mode or the weight stationary mode.

Therefore, it is desirable to provide a reconfigurable processing element for a systolic array that is configurable for multiplying a first matrix with a second matrix to determine a result matrix in a weight stationary mode or in an output stationary mode. If desired, such a reconfigurable processing element may be integrated into a coarse-grained reconfigurable architecture.

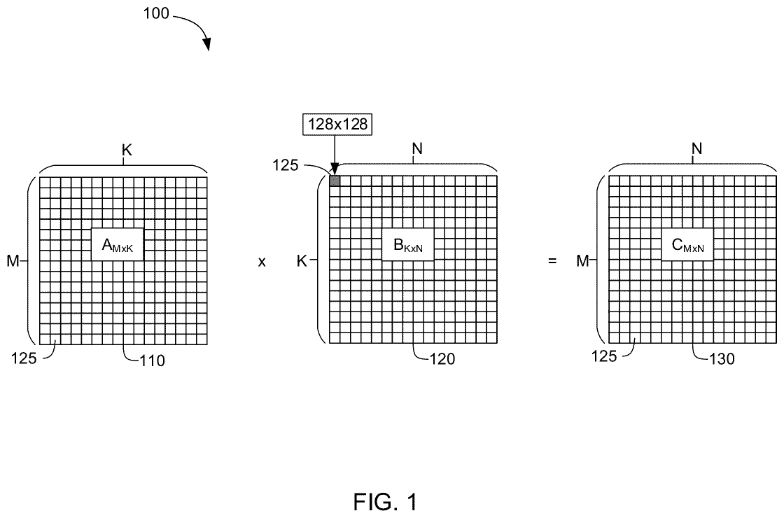

FIG. 1 is a diagram of an illustrative matrix multiplication 100 of a first matrix A 110 with a second matrix B 120 to produce a result matrix C 130. Illustratively, the first matrix A 110 has M rows and K columns, the second matrix B 120 has K rows and N columns, and the result matrix C 130 has M rows and N columns.

As an example, consider the scenario in which every square element 125 of matrices A 110, B 120, and C 130 includes 128 rows and 128 columns. Consider further that each one of matrices A 110, B 120, and C 130 has 16 rows and 16 columns of square elements 125 for a total of 256 square elements from square element 0, 0 to square element 15, 15. In this scenario, matrix A 110 has M=2048 rows and K=2048 columns, matrix B has K=2048 rows and N=2048 columns, and matrix C has M=2048 rows and N=2048 columns.

In this example, M is equal to K and equal to N. However, M, K, and N may be different numbers, and thus the matrices may have different dimensions, if desired.

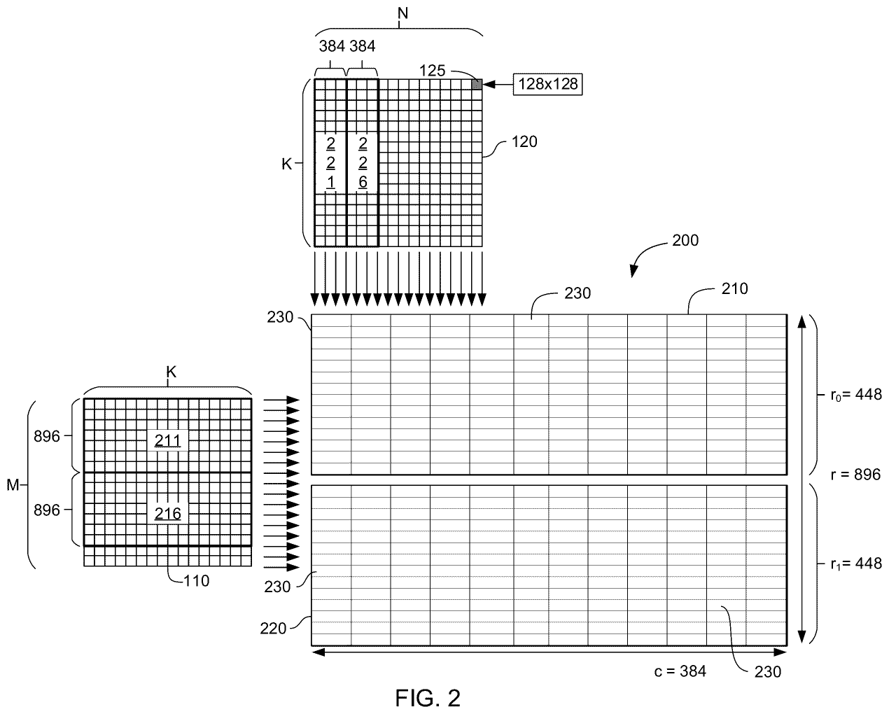

FIG. 2 is a diagram of an illustrative reconfigurable processor 200 that is configured to perform a matrix multiplication of the first matrix A 110 with the second matrix B 120 of FIG. 1 in an output stationary mode. The reconfigurable processor may be a coarse-grained reconfigurable processor, if desired.

Illustratively, the reconfigurable processor 200 may include two tiles, tile 210 and tile 220. As shown in FIG. 2, tile 210 may be arranged vertically on top of tile 220. However, tile 210 may be arranged horizontally next to tile 220, if desired. In some implementations, the reconfigurable processor 200 may include only one tile, so that the two tiles are in two different reconfigurable processors. In other implementations, the reconfigurable processor 200 may include more than two tiles. For example, the reconfigurable processor 200 may include three, four, or more tiles.

The tiles may be arranged in any way relative to each other. As an example, four tiles may be arranged two-by-two tiles in a same plane. As another example, all four tiles may be arranged in a row or in a column. As yet another example, two tiles may be arranged in a same plane next to each other and the other two tiles may be arranged in another plane next to each other, whereby the two planes may be vertically stacked.

In some implementations, tile 210 and tile 220 may each include an array of reconfigurable processing elements. The reconfigurable processing elements may be grouped in programmable compute units (PCUs), if desired. A tile 210, 220 may include any number of rows and columns of PCUs 230 having any number of reconfigurable processing elements.

As an example, consider the scenario shown in FIG. 2 in which tile 210 and tile 220 each have 14 rows and 12 columns of PCUs 230. Consider further that each PCU 230 has 32 rows of reconfigurable processing units and 32 columns of reconfigurable processing units. Thus, each PCU 230 has 1024 reconfigurable processing units, each tile 210, 220 has c=384 columns of reconfigurable processing elements and 448 rows of reconfigurable processing elements, and both tiles as arranged in FIG. 2 have a total of r=896 rows of reconfigurable processing elements.

Tile 210 and tile 220 may together be configured to implement a systolic array for multiplying matrix A 110 with matrix B 120 in the output stationary mode. In the output stationary mode, the result matrix (e.g., matrix C 130 of FIG. 1) may be initialized to zero inside the reconfigurable processing elements of the systolic array. Matrices A 110 and B 120 may be streamed into the systolic array. As shown in FIG. 2, matrix A 110 is streamed into the systolic array from the left and matrix B 120 is streamed into the systolic array from the top. However, matrices A and B may be streamed into the systolic array from any two sides depending on the configuration of the reconfigurable processing elements and the connectivity within the systolic array. For example, matrix A may be streamed from the top and matrix B from the left, or matrix A may be streamed into the systolic array from the bottom and matrix B from the right, just to name a few alternatives for streaming the matrices A and B into the systolic array.

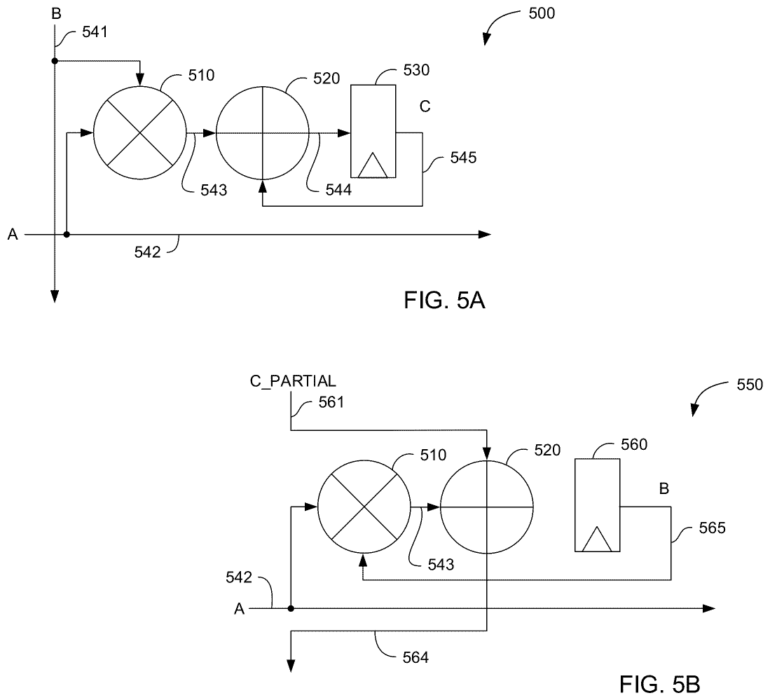

Each reconfigurable processing element implements a multiply-accumulate function and computes a single element of the result matrix C:

$$c [ m ] [ n ] += a [ m ] [ k ] * b [ k ] [ n ] \qquad ( 1 )$$

where k is iterated in time from 0 to K and m and n are spatial indices of the row and the column of the reconfigurable processing element, respectively. After k=K steps, the matrix C is streamed out from the bottom of the systolic array. An illustrative processing element that operates in the output stationary mode is shown in FIG. 5A.

However, in the present example of FIG. 2, the number of rows of reconfigurable processing elements of the two tiles r=896 is smaller than the number of rows M=2048 of matrix A 110. Furthermore, the number of columns of reconfigurable processing elements of the two tiles c=384 is smaller than the number of columns N=2048 of matrix B 120. Consequently, if M>r, matrix multiplication in the output stationary mode requires multiple row iterations, and if N>c, matrix multiplication in the output stationary mode requires multiple column iterations.

In some implementations, the portions of matrices A 110 and B 120 that are to be multiplied are loaded from off-chip memory (e.g., DRAM) into on-chip memory (e.g., SRAM) of the systolic array, and the portions of the matrices are then streamed into the systolic array from the on-chip memory. Similarly, the result matrix may first be stored in on-chip memory before the result matrix is moved to off-chip memory. However, the size of the on-chip memory may be limited, and the matrix multiplication operation may require multiple load operations from off-chip memory to on-chip memory and multiple store operations of portions of the result matrix from on-chip memory to off-chip memory depending on the dimensions M, N, and K of the matrices.

In the present example, in a first iteration, the two tiles 210, 220 may multiply the elements in the rectangle 211 that includes the upper 896 rows (i.e., row 0 to row 895) and K columns of matrix A 110 with the elements in the rectangle 221 that includes the K rows and the leftmost 384 columns (i.e., column 0 to column 383) of matrix B 120 to determine the upper left rectangle of the result matrix including 896 rows and 384 columns (i.e., rows 0 to 895 and columns 0 to 383 of the result matrix), which are streamed out and stored (e.g., on an SRAM circuit on the reconfigurable processor 200 and from there copied to a DRAM circuit outside the reconfigurable processor 200).

In a second iteration, the two tiles 210, 220 may multiply the elements in the rectangle 211 that includes the upper 896 rows and K columns of matrix A 110 with the elements in the rectangle 226 that includes the K rows and the next 384 columns (i.e., column 384 to column 767) of matrix B 120 to determine the elements in the rectangle that includes rows 0 to 895 and columns 384 to 767 of the result matrix.

Alternatively, in the second iteration, the two tiles 210, 220 may multiply the elements in the rectangle 216 that includes the next 896 rows (i.e., rows 896 to 1791) and K columns of matrix A 110 with the elements in the rectangle 221 that includes the K rows and the leftmost 384 columns (i.e., column 0 to column 383) of matrix B 120 to de determine the elements in the rectangle that includes rows 896 to 1791 and columns 0 to 383 of the result matrix.

The iterations continue until the entire result matrix has been determined. In the present example, the two tiles 210, 220 may determine the entire result matrix in 18 iterations.

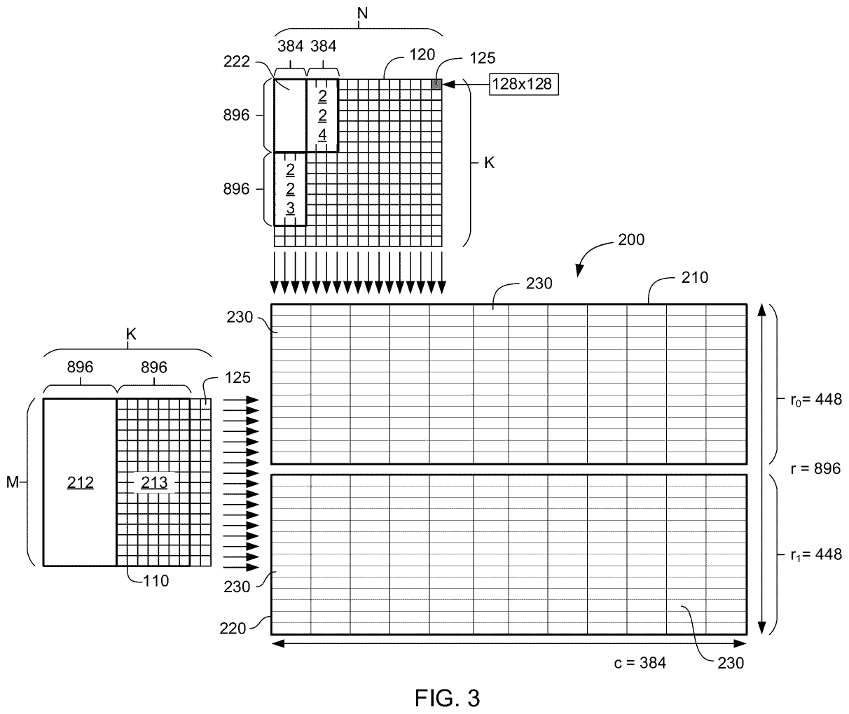

FIG. 3 is a diagram of an illustrative reconfigurable processor that is configured to perform a matrix multiplication of matrix A 110 with matrix B 120 of FIG. 1 in a weight stationary mode. Illustratively, the reconfigurable processor is the reconfigurable processor 200 with tiles 210 and 220 described in FIG. 2 above.

In contrast to FIG. 2, tile 210 and tile 220 of FIG. 3 may together be configured to implement a systolic array for multiplying matrix A 110 with matrix B 120 in the weight stationary mode. In the weight stationary mode, one of matrix A 110 or matrix B 120 is preloaded into internal registers of the processing elements within the systolic array. As an example, matrix B 120 may be preloaded from the top and matrix A 110 may be streamed into the systolic array from the left. As another example, matrix A 110 may be preloaded from the top and matrix B 120 may be streamed into the systolic array from the left. As yet another example, matrix B 120 may be preloaded from the bottom and matrix A 110 may be streamed into the systolic array from the right. For simplicity and conciseness, in the remainder of the description of FIG. 3, consider the scenario in which matrix B 120 is preloaded from the top, and matrix A 110 is streamed from the left.

In the weight stationary mode, the multiplier circuit in a processing element multiplies a number of matrix A 110 received from the left with a number of matrix B 120 that is stored in the internal register of the processing element (i.e., stationary) to generate a product. The adder circuit in the processing element adds the product to a partial sum received from the processing element above to generate an updated partial sum. The processing element outputs the updated partial sum at the bottom for transmission to the processing element below. An illustrative processing element that operates in the weight stationary mode is shown in FIG. 5B.

At the bottom of the systolic array, the partial sums may be buffered and accumulated before the result matrix C 130 is produced as a final output and copied to storage circuitry outside the reconfigurable processor 200.

In the present example of FIG. 3, the number of rows of reconfigurable processing elements of the two tiles r=896 is smaller than the number of rows K=2048 of matrix B 120. Furthermore, the number of columns of reconfigurable processing elements of the two tiles c=384 is smaller than the number of columns N=2048 of matrix B 120. Consequently, if K>r or N>c, matrix multiplication in the weight stationary mode requires loading of each tile (i.e., tile 222, tile 223, tile 224, etc.) of matrix B 120 at least once per block matrix multiplication.

In the present example, in a first iteration, the elements in the rectangle 222 in the upper left corner of matrix B 120 including 896 rows (i.e., rows 0 to 895) and 384 columns (i.e., columns 0 to 383) are preloaded into the internal registers of the two tiles 210, 220 during a load phase that occurs before matrix A 110 is streamed into the systolic array.

In some implementations, the internal registers of the two tiles 210, 220 may be enabled for a write operation only during the load phase. After the load phase has terminated, the systolic array may multiply the elements in the rectangle 212 that includes the M rows and leftmost 896 columns of matrix A 110 with the elements in the rectangle 222 that includes the uppermost 896 rows (i.e., row 0 to row 895) and the leftmost 384 columns (i.e., column 0 to column 383) of matrix B 120 to determine partial results of the leftmost 384 columns of the result matrix, which are streamed from the top of tile 210 to the bottom of tile 220 and added to the partial results in the processing elements that are traversed. The resulting partial results are stored on-chip at the bottom of the systolic array or off-chip (e.g., on a DRAM circuit outside the systolic array).

In a second iteration, the elements in the rectangle 223 of 896 rows and 384 columns below the rectangle 222 in the upper left corner of matrix B 120 (i.e., rows 896 to 1791 and columns 0 to 383) is preloaded into the internal registers of the two tiles 210, 220 during a second load phase. After the second load phase has terminated, the systolic array may multiply the elements in the rectangle 212 that includes the M rows and 896 leftmost columns (i.e., columns 0 to 895) of matrix A 110 with the elements in the rectangle 223 that includes the next 896 rows and 384 columns of matrix B and add the results to the partial results determined during the first iteration.

As an alternative, in the second iteration, the two tiles 210, 220 may keep the elements in the rectangle 222 in the upper left corner of matrix B 120 of the first iteration in the internal registers, and the systolic array may multiply the elements in the rectangle 213 that includes the M rows and 896 next columns (i.e., columns 896 to 1791) of matrix A 110 with the elements in the rectangle 222 that includes the uppermost 896 rows and the leftmost 384 columns of matrix B 120 and add the results to the partial results determined during the first iteration.

As another alternative, in the second iteration, the elements in the rectangle 224 of 896 rows and 384 columns to the right of the rectangle 222 of matrix B 120 (i.e., rows 0 to 895 and columns 384 to 767) may be preloaded into the internal registers of the two tiles 210, 220 during the second load phase. After the load phase has terminated, the systolic array may multiply the elements in the rectangle 212 that includes the M rows and leftmost 896 columns of matrix A 110 with the elements in the rectangle 224 that includes row 0 to 895 and columns 384 to 767 of matrix B to determine partial results of the second leftmost 384 columns of the result matrix, which are produced and stored on-chip at the bottom of the systolic array or off-chip (e.g., on a DRAM circuit outside the systolic array).

The iterations continue until the entire result matrix has been determined. In the present example, the two tiles 210, 220 may have determined the entire result matrix in 54 iterations.

Depending on the dimensions M, K, and N of the matrices (e.g., dimensions M, K, and N of matrices A 110 and B 120 of FIG. 1) and depending on the architecture of the systolic array, the on-chip memory capacity, the load time and energy requirements of loading into the on-chip memory, one of the output stationary mode or the weight stationary mode may be advantageous over the other one in terms of bandwidth, memory bandwidth, in terms of energy, and/or in terms of performance.

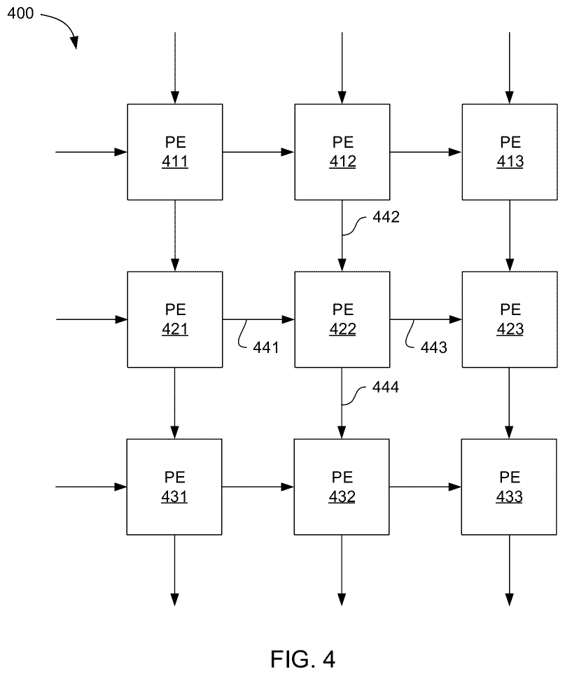

FIG. 4 is a diagram of an illustrative systolic array 400 with a plurality of reconfigurable processing elements. In FIG. 4, the illustrative systolic array 400 is shown with nine reconfigurable processing elements 411, 412, 413, 421, 422, 423, 431, 432, 433 to illustrate the connectivity between the reconfigurable processing elements in the systolic array 400. However, the systolic array may include more than nine reconfigurable processing elements, if desired.

The systolic array 400 is suitable for performing matrix multiplication of a first matrix (e.g., matrix A 110 of FIG. 1) and a second matrix (e.g., matrix B 120 of FIG. 1) to determine a result matrix (e.g., matrix C 130 of FIG. 1). The reconfigurable processing elements 411, 412, 413, 421, 422, 423, 431, 432, 433 are configurable for operating in a weight stationary mode or in an output stationary mode.

In the output stationary mode, the first matrix may be streamed into the systolic array 400 from the left (i.e., first into reconfigurable processing elements 411, 421, and 431), whereby the first, second, and third rows of the first matrix are streamed into the first, second, and third rows of the systolic array 400, respectively. The second matrix may be streamed into the systolic array 400 from the top (i.e., first into reconfigurable processing elements 411, 412, and 413), whereby the first, second, and third columns of the second matrix are streamed into the first, second, and third columns of the systolic array 400, respectively.

Consider the scenario in which every reconfigurable processing element stores the incoming signal in a register and produces the signal at the output after one clock cycle. For example, reconfigurable processing element 422 may send the signal received via connection 441 from reconfigurable processing element 421 one clock cycle later to reconfigurable processing element 423 via connection 443. Similarly, reconfigurable processing element 422 may send the signal received via connection 442 from reconfigurable processing element 412 one clock cycle later to reconfigurable processing element 432 via connection 444. In this scenario, the input from the top into reconfigurable processing elements 412 respectively 413 may be delayed by one, respectively two, clock cycles compared to the input from the top into reconfigurable processing element 411. Similarly, the input from the left into reconfigurable processing elements 421 respectively 431 may be delayed by one, respectively two, clock cycles compared to the input from the left into reconfigurable processing element 411.

In the weight stationary mode, the first matrix may be streamed into the systolic array 400 from the left (i.e., first into reconfigurable processing elements 411, 421, and 431). As an example, the first, second, and third columns of the first matrix may be streamed into the first, second, and third rows of the systolic array 400, respectively. The second matrix is stored in the internal registers of the reconfigurable processing elements. In the example, the first, second, and third columns of matrix B may be stored in the internal registers of the first, second, and third columns of the systolic array 400, respectively.

For example, elements b₁₁, b₂₁, and b₃₁ may be stored in reconfigurable processing elements 411, 421, and 431, respectively, elements b₁₂, b₂₂, and b₃₂ may be stored in reconfigurable processing elements 412, 422, and 432, respectively, and elements b₁₃, b₂₃, and b₃₃ may be stored in reconfigurable processing elements 413, 423, and 433, respectively, whereas elements a₁₁, a₂₁, and a₃₁ may successively be streamed into reconfigurable processing elements 411, 412, and 413, respectively, elements a₁₂, a₂₂, and a₃₂ may successively be streamed into reconfigurable processing elements 421, 422, and 423, respectively, and elements a₁₃, a₂₃, and a₃₃ may successively be streamed into reconfigurable processing elements 431, 432, and 433, respectively. Thus, in this example, reconfigurable processing element 431 may successively output elements c₁₁, c₂₁, and c₃₁ of the result matrix, reconfigurable processing element 432 may successively output elements c₁₂, c₂₂, and c₃₂ of the result matrix, and reconfigurable processing element 433 may successively output elements c₁₃, c₂₃, and c₃₃ of the result matrix.

FIG. 5A is a diagram of an illustrative processing element 500 operating in an output stationary mode. As shown, the processing element 500 includes a multiplier circuit 510, an adder circuit 520, and an internal register 530. The adder circuit 520 and the internal register 530 may form an accumulator circuit.

The processing element 500 has first and second input ports and first and second output ports. Connection 542 may couple the first input port with the first output port, and connection 541 may couple the second input port with the second output port. Respective delay registers in connections 541 and 542 have been omitted for simplicity of the representation.

Illustratively, the processing element 500 may receive an element of a matrix A at the first input port and transmit the element of matrix A via connection 542 to the multiplier circuit 510 and to the first output port. Similarly, the processing element 500 may receive an element of matrix B at the second input port and transmit the element of matrix B via connection 541 to the multiplier circuit 510 and to the second output port.

Multiplier circuit 510 generates a product of the element of matrix A and the element of matrix B and transmits the product via connection 543 to the adder circuit 520. The adder circuit 520 generates a sum of the product and a partial result matrix element stored in internal register 530 received via connection 545. The sum is transmitted via connection 544 to the internal register 530, where the sum is stored as a new partial result matrix element.

For example, the processing element 500 may receive K elements of the first row of matrix A at the first input port and K elements of the first column of matrix B at the second input port. The internal register 530 is initialized to zero and stores the element in the first row and the first column of the result matrix C after K iterations. Thus:

$${C}_{11} = {\sum }_{k = 1}^{K} ( {a}_{1 k} {b}_{k 1} ) \qquad ( 2 )$$

The element in the first row and the first column of the result matrix c₁₁ is output from the internal register 530 of the processing element 500 at the end of the matrix multiplication of the first row of matrix A with the first column of matrix B.

FIG. 5B is a diagram of an illustrative processing element 550 operating in a weight stationary mode. As shown, the processing element 550 includes a multiplier circuit 510, an adder circuit 520, and an internal register 560.

The processing element 550 has first and second input ports and first and second output ports. Connection 542 may couple the first input port with the first output port and multiplier circuit 510. Connection 561 may couple the second input port with the adder circuit 520, and connection 564 may couple the adder circuit 520 with the second output port. Respective delay registers in connections 541 and 564 have been omitted for simplicity of the representation.

During a load phase, an element of matrix B may be loaded into the internal register 560. The element of matrix B may be transmitted via connection 565 to the multiplier circuit. Illustratively, the processing element 550 may receive an element of a matrix A at the first input port and transmit the element of matrix A via connection 542 to the multiplier circuit 510 and to the first output port. The processing element 550 may receive a partially determined element of the result matrix at the second input port and transmit the partially determined element of the result matrix via connection 561 to the adder circuit 520.

Multiplier circuit 510 generates a product of the element of matrix A and the element of matrix B and transmits the product via connection 543 to the adder circuit 520. The adder circuit 520 generates a sum of the product and the partially determined element of the result matrix. The sum is transmitted via connection 564 to the second output port.

For example, the processing element 550 may store an element of the first column of matrix B in the internal register 560 and receive M elements of the first column of matrix A at the first input port. In this example, the partially determined elements of the first column of the result matrix may be successively output from the processing element 550 at the second output port.

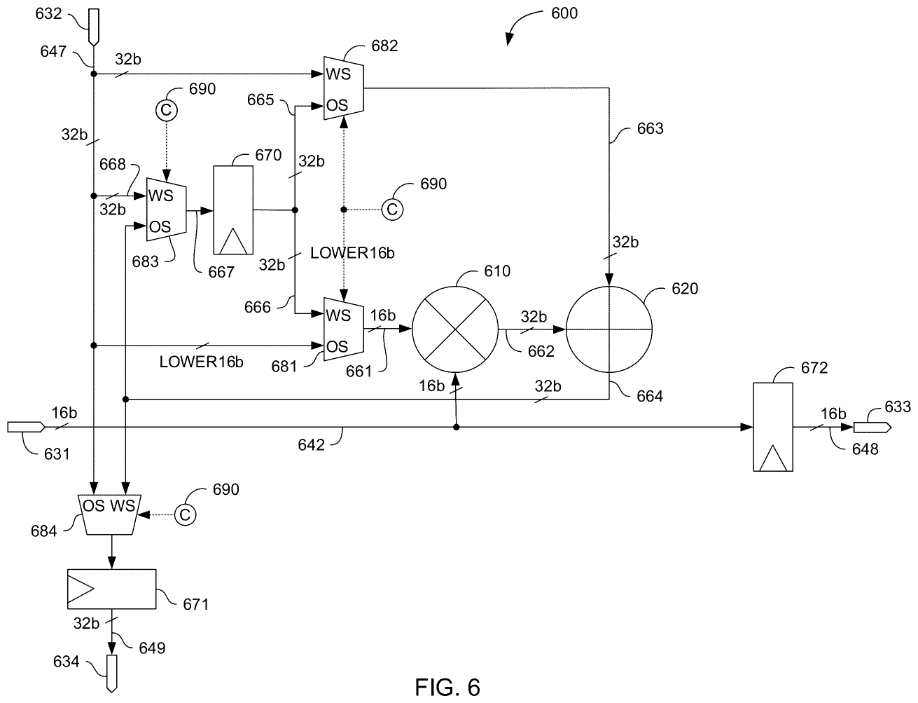

FIG. 6 is a diagram of an illustrative reconfigurable processing element 600 for a systolic array (e.g., systolic array 400 of FIG. 4) that is configurable for multiplying a first matrix (e.g., matrix A 110 of FIG. 1) with a second matrix (e.g., matrix B 120 of FIG. 1) to determine a result matrix (e.g., matrix C 130 of FIG. 1) in a weight stationary mode or in an output stationary mode.

The reconfigurable processing element 600 includes first and second input ports 631, 632, first and second multiplexer circuitry 681, 682, an internal register 670, a multiplier circuit 610, and an adder circuit 620.

The multiplier circuit 610 generates a product of a number of the first matrix received from the first input port 631 and a number of the second matrix received from the first multiplexer circuitry 681 (e.g., via connection 661), whereby the first multiplexer circuitry 681 routes the number of the second matrix from the internal register 670 to the multiplier circuit 610 in the weight stationary mode and from the second input port 632 to the multiplier circuit 610 in the output stationary mode based on a control signal 690.

In some implementations, the control signal 690 may be an external signal that the reconfigurable processing element 600 receives at an additional input port. In other implementations, a configuration storage circuit may store the control signal 690 inside the reconfigurable processing element 600. The control signal 690 may be indicative of whether the reconfigurable processing circuit 600 is configured to operate in the weight stationary mode or the output stationary mode and control the selection of the first and second multiplexer circuitries 681, 682 accordingly.

The adder circuit 620 generates a sum of the product received from the multiplier circuit 610 (e.g., via connection 662) and a number of a partially determined element of the result matrix received from the second multiplexer circuitry 682, whereby the second multiplexer circuitry 682 routes the number of the partially determined element of the result matrix from the second input port 632 to the adder circuit 620 in the weight stationary mode and from the internal register 670 to the adder circuit 620 in the output stationary mode based on the control signal 690.

Illustratively, the reconfigurable processing element may include output port 633 and output register 672 that is coupled to the output port 633, for example via connection 648. Output register 672 may receive the number of the first matrix from the first input port 631, for example via connection 642. Connection 642 may also provide the number of the first matrix from the first input port 631 to the multiplier circuit 610.

As shown in FIG. 6, the reconfigurable processing element 600 may include multiplexer circuitry 684 that provides as a selected signal the sum from the adder circuit 620 in the weight stationary mode and the number of the second matrix from the second input port 632 in the output stationary mode based on the control signal 690. For example, the multiplexer circuitry 684 may receive the sum from the adder circuit 620 via connection 664 in the weight stationary mode and the number of the second matrix from the second input port 632 via connection 647 in the output stationary mode.

By way of example, the reconfigurable processing element 600 may include output port 634 and output register 671 that is coupled to the output port 634. Output register 671 may receive the selected signal from multiplexer circuitry 684, for example via connection 649.

Illustratively, the reconfigurable processing element 600 may include multiplexer circuitry 683 coupled to the internal register 670, for example via connection 667. The multiplexer circuitry 683 routes the number of the second matrix from the second input port 632 to the internal register 670 in the weight stationary mode (e.g., via connections 647, 668) and the sum from the adder circuit 620 to the internal register 670 in the output stationary mode (e.g., via connection 664) based on the control signal 690. Thus, in the output stationary mode, the internal register 670 stores an accumulated number of the result matrix, whereas in the weight stationary mode, the internal register 670 stores a number of the second matrix.

In some implementations, the number of the first matrix, the number of the second matrix, and the accumulated number of the result matrix may have the same data format. For example, all three numbers may have one of the data formats half-precision floating-point (FP16), single-precision floating-point (FP32), double-precision floating-point (FP64), brain floating-point (BF16 or BFLOAT16), or tensor-float 32 (TF32), if desired. In these implementations, the multiplier circuit 610 may multiply the multiplicands and normalize the result to the data format of the multiplicands as part of generating the product. Similarly, the adder circuit 620 may add the summands and normalize the result to the data format of the summands as part of generating the sum.

In other implementations, the number of the first matrix, the number of the second matrix, and the accumulated number of the result matrix may have a different data format. As an example, the numbers of the first and second matrices may both have a BF16 format, and the accumulated number of the result matrix may have a TF32 format. As another example, the numbers of the first and second matrices may both have a TF32 format, and the accumulated number of the result matrix may have a FP32 format. As yet another example, the numbers of the first and second matrices may both have a BF16 format, and the accumulated number of the result matrix may have a FP32 format.

For the purpose of simplifying the discussion and without loss of generality, consider the scenario of FIG. 6 in which the numbers of the first and second matrices are encoded using 16 bits (e.g., having data format BF16) and in which the accumulated number of the result matrix is encoded using 32 bits (e.g., having data format FP32). In this scenario, the multiplier circuit 610 may receive the numbers of the first and second matrices that are encoded using 16 bits and generate a product that has 32 bits, whereas the adder circuit may receive two 32-bit numbers and generate a sum that has 32 bits. Thus, the first input port 631 has a first bit width (e.g., 16 bits) and the second input port has a second bit width (e.g., 32 bits) so that the second bit width is at least twice as large as the first bit width.

The number of the second matrix is received at the second input port 632 in the output stationary mode. As an example, the number of the second matrix may use the least significant bits of the second bit width. As another example, the number of the second matrix may use the most significant bits of the second bit width.

Illustratively, the multiplexer circuitries 681 and 682 may include a plurality of two-input multiplexers that are each controlled by the control signal 690. In some implementations, the second multiplexer circuitry 682 may include at least twice as many two-input multiplexers as the first multiplexer circuitry. As an example, the first multiplexer circuitry 681 may include 16 two-input multiplexers to select between the 16 bits of the number of the second matrix stored in the internal register in the weight stationary mode and the 16 bits of the number of the second matrix received from input port 632 in the output stationary mode, and the second multiplexer circuitry 682 may include 32 two-input multiplexers to select between the 32 bits of the accumulated number of the result matrix stored in the internal register 670 in the output stationary mode and the 32 bits of the accumulated number of the result matrix received from input port 632 in the weight stationary mode.

In some implementations, the internal register 670 may include a plurality of one-bit registers. In the scenario in which the numbers of the first and second matrices are encoded using 16 bits and in which the accumulated number of the result matrix is encoded using 32 bits, the internal register 670 has 32 one-bit registers so that the internal register 670 can store the accumulated number of the result matrix from the adder circuit 620 in the output stationary mode. The internal register 670 may provide the accumulated number of the result matrix via connection 665, multiplexer circuitry 681, and connection 663 to the adder circuit 620.

However, in the weight stationary mode, the internal register 670 stores only the 16 bits of the number of the second matrix received from the second input port 632. Thus, the number of the second matrix is stored in at most half of the 32 one-bit registers of the internal register 670 in the weight stationary mode. The internal register 670 may provide the number of the second matrix via the lower 16 bits of connection 666 to the multiplier circuit 610.

Illustratively, the output registers 671, 672 may include a plurality of one-bit registers. In the scenario in which the numbers of the first and second matrices are encoded using 16 bits and in which the accumulated number of the result matrix is encoded using 32 bits, output register 672 has 16 one-bit registers, and output register 671 has 32 one-bit registers.

As mentioned above, in the output stationary mode, the multiplexer circuitry 683 routes the number of the second matrix from the second input port 632 via connections 647 and 668, multiplexer circuitry 683 and connection 667 to the internal register 670 during a load phase (e.g., before the numbers of the first matrix are streamed into the first input port 631). However, in the weight stationary mode, input port 632 receives the accumulated number of the result matrix from another reconfigurable processing element, which is also routed via connections 647 and 668, multiplexer circuitry 683, and connection 667 to the internal register 670 during a multiplication phase (e.g., while the numbers of the first matrix are streamed into the first input port 631). Thus, the internal register 670 is enabled for receiving the number of the second matrix in the weight stationary mode only during the load phase.

Turning back now to the systolic array 400 of FIG. 4 that is suitable for performing matrix multiplication of a first matrix and a second matrix to determine a result matrix. As shown in FIG. 4, the systolic array 400 includes a plurality of reconfigurable processing elements 411, 412, 413, 421, 422, 423, 431, 432, 433 that are configurable for operating in a weight stationary mode or in an output stationary mode.

In the systolic array 400, each one of a first 412, second 421, third 422, fourth 423, and fifth 432 reconfigurable processing element of the plurality of reconfigurable processing elements includes first and second input ports (e.g., input ports 631, 632 of FIG. 6), first and second multiplexer circuitry (e.g., multiplexer circuitry 681, 682 of FIG. 6), an internal register (e.g., register 670 of FIG. 6), a multiplier circuit (e.g., multiplier circuit 610 of FIG. 6), and an adder circuit (e.g., adder circuit 620 of FIG. 6). In the third reconfigurable processing element 422, the multiplier circuit generates a product of a number of the first matrix received from the first input port and a number of the second matrix received from the first multiplexer circuitry, whereby the first multiplexer circuitry routes the number of the second matrix from the internal register to the multiplier circuit in the weight stationary mode and from the second input to the multiplier circuit in the output stationary mode based on a control signal.

Furthermore, in the third reconfigurable processing element 422, the adder circuit generates a sum of the product received from the multiplier circuit and a number of a partially determined element of the result matrix received from the second multiplexer circuitry, whereby the second multiplexer circuitry routes the number of the partially determined element of the result matrix from the second input port to the adder circuit in the weight stationary mode and from the internal register to the adder circuit in the output stationary mode based on the control signal.

Illustratively, each one of the first 412, second 421, third 422, fourth 423, and fifth 432 reconfigurable processing elements of the systolic array 400 may include first and second output ports (e.g., output ports 633, 634 of FIG. 6), first and second output registers (e.g., output registers 672, 671 of FIG. 6), and third multiplexer circuitry (e.g., multiplexer circuitry 684 of FIG. 6). In the third reconfigurable processor circuit 422, the first output register may be coupled to the first output port and receive the number of the first matrix from the first input port, the second output register may be coupled to the second output port, and the third multiplexer circuitry may route the sum from the adder circuit to the second output register in the weight stationary mode and the number of the second matrix from the second input port to the second output register in the output stationary mode based on the control signal.

By way of example, the first input port (e.g., input port 631 of FIG. 6) of the third reconfigurable processing element 422 may be coupled to the first output port (e.g., output port 633 of FIG. 6) of the second reconfigurable processing element 421, the second input port (e.g., input port 632 of FIG. 6) of the third reconfigurable processing element 422 may be coupled to the second output port (e.g., output port 634 of FIG. 6) of the first reconfigurable processing element 412, the first output port (e.g., output port 633 of FIG. 6) of the third reconfigurable processing element 422 may be coupled to the first input port (e.g., input port 631 of FIG. 6) of the fourth reconfigurable processing element 423, and the second output port (e.g., output port 634) of the third reconfigurable processing element 422 may be coupled to the second input port (e.g., input port 632 of FIG. 6) of the fifth reconfigurable processing element 432.

Illustratively, each one of the first 412, second 421, third 422, fourth 423, and fifth 432 reconfigurable processing elements of the systolic array 400 may include third multiplexer circuitry (e.g., multiplexer circuitry 683 of FIG. 6) coupled to the internal register. In the third reconfigurable processing element 422, the third multiplexer circuitry may route the number of the second matrix from the second input port to the internal register in the weight stationary mode and the sum from the adder circuit to the internal register in the output stationary mode based on the control signal. However, the internal register may be enabled for receiving the number of the second matrix in the weight stationary mode only during a load phase.

In some implementations, in each one of a first 412, second 421, third 422, fourth 423, and fifth 432 reconfigurable processing element of the systolic array 400, the first input port may have a first bit width and the second input port a second bit width that is at least twice as large as the first bit width. If desired, the second multiplexer circuitry in the reconfigurable processing elements 412, 421, 422, 423, 432 may include at least twice as many two input multiplexers as the first multiplexer circuitry.

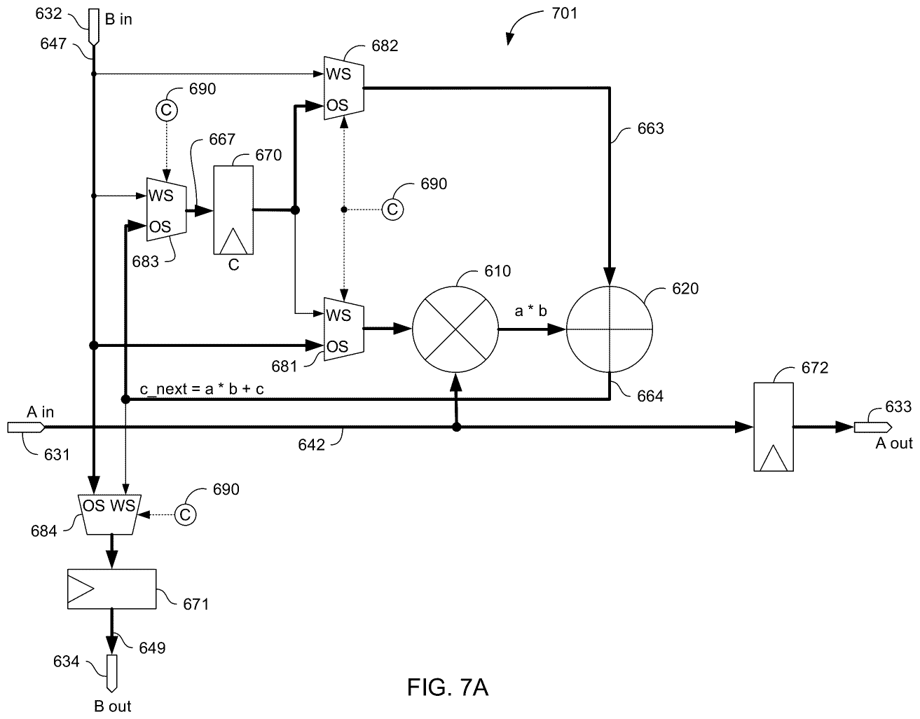

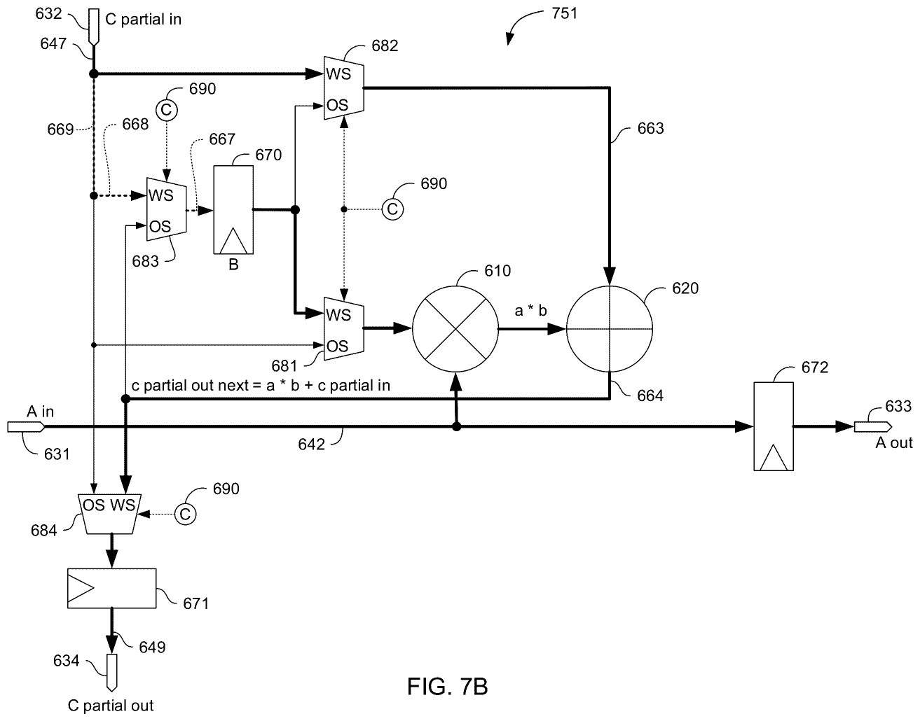

FIG. 7A is a diagram of the illustrative reconfigurable processing element 600 of FIG. 6 configured to operate in the output stationary mode 701. In the output stationary mode, the reconfigurable processing element receives a number of the first matrix at the first input port 631 and a number of the second matrix at the second input port 632. Furthermore, the control signal 690, which may be an external signal that the reconfigurable processing element 600 receives at an additional input port or a signal stored in a configuration storage circuit inside the reconfigurable processing element 600, controls the selection of the multiplexer circuitries 681, 682, 683, 684 such that the respective multiplexer circuitries select an incoming signal at the OS port.

Thus, in the output stationary mode, multiplexer circuitry 681 routes the number of the second matrix from the second input port 632 to the multiplier circuit 610, multiplexer circuitry 684 routes the number of the second matrix from the second input port 632 to the output register 671, multiplexer circuitry 682 routes the number of the partially determined element of the result matrix from the internal register 670 to the adder circuit 620, and the multiplexer circuitry 683 routes the sum, which includes the updated number of the partially determined element of the result matrix, from the adder circuit 620 back to the internal register 670.

FIG. 7B is a diagram of the illustrative reconfigurable processing element 600 of FIG. 6 configured to operate in the weight stationary mode 751. In the weight stationary mode, the reconfigurable processing element receives a number of the first matrix at the first input port 631 and a number of the partially determined element of the result matrix at the second input port 632. Furthermore, the control signal 690, which may be an external signal that the reconfigurable processing element 600 receives at an additional input port or a signal stored in a configuration storage circuit inside the reconfigurable processing element 600, controls the selection of the multiplexer circuitries 681, 682, 683, 684 such that the respective multiplexer circuitries select an incoming signal at the WS port.

Thus, in the weight stationary mode, multiplexer circuitry 683 routes the number of the second matrix from the second input port 632 via connections 669, 668, 667 to the internal register 670 only during a load phase, multiplexer circuitry 681 routes the number of the second matrix from the internal register 670 to the multiplier circuit 610, multiplexer circuitry 682 routes the number of the partially determined element of the result matrix from the second input port 632 to the adder circuit 620, and multiplexer circuitry 684 routes the sum from the adder circuit 620 to the output register 671.

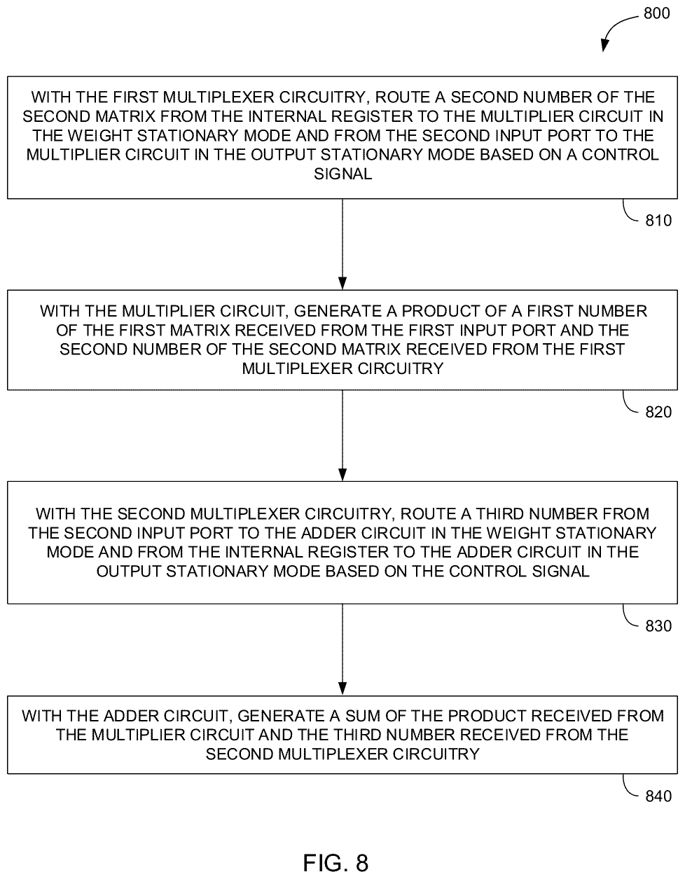

FIG. 8 is a flowchart 800 showing illustrative operations of a reconfigurable processing element (e.g., reconfigurable processing element 600 of FIG. 6) for a systolic array (e.g., systolic array 400 of FIG. 4) that is configured for performing matrix multiplication of a first matrix (e.g., matrix A 110 of FIG. 1) and a second matrix (e.g., matrix B 120 of FIG. 1) to determine a result matrix (e.g., matrix C 130 of FIG. 1) in a weight stationary mode or in an output stationary mode. The reconfigurable processing element includes first and second input ports (e.g., input ports 631, 632 of FIG. 6), first and second multiplexer circuitry (e.g., multiplexer circuitry 681, 682 of FIG. 6), an internal register (e.g., internal register 670 of FIG. 6), a multiplier circuit (e.g., multiplier circuit 610 of FIG. 6), and an adder circuit (e.g., adder circuit 620 of FIG. 6).

During operation 810, the reconfigurable processing element routes, with the first multiplexer circuitry, a number of the second matrix from the internal register to the multiplier circuit in the weight stationary mode and from the second input port to the multiplier circuit in the output stationary mode based on a control signal.

For example, the reconfigurable processing element 600 of FIG. 6 routes, with multiplexer circuitry 681, a number of the second matrix from the internal register 670 to the multiplier circuit 610 in the weight stationary mode and from input port 632 to the multiplier circuit 610 in the output stationary mode based on control signal 690.

During operation 820, the reconfigurable processing element generates, with the multiplier circuit, a product of a number of the first matrix received from the first input port and the number of the second matrix received from the first multiplexer circuitry.

For example, the reconfigurable processing element 600 of FIG. 6 generates, with the multiplier circuit 610, a product of a number of the first matrix received from input port 631 and the number of the second matrix received from multiplexer circuitry 681.

During operation 830, the reconfigurable processor routes, with the second multiplexer circuitry, a number of a partially determined element of the result matrix from the second input port to the adder circuit in the weight stationary mode and from the internal register to the adder circuit in the output stationary mode based on the control signal.

For example, the reconfigurable processing element 600 of FIG. 6 routes, with multiplexer circuitry 682, a number of a partially determined element of the result matrix from input port 632 to the adder circuit 620 in the weight stationary mode and from the internal register 670 to the adder circuit 620 in the output stationary mode based on the control signal 690.

During operation 840, the reconfigurable processor generates, with the adder circuit, a sum of the product received from the multiplier circuit and the number of the partially determined element of the result matrix received from the second multiplexer circuitry.

For example, the reconfigurable processing element 600 of FIG. 6 generates, with the adder circuit 620, a sum of the product received from the multiplier circuit 610 and the number of the partially determined element of the result matrix received from multiplexer circuitry 682.

In some implementations, the reconfigurable processing element may include first and second output registers and third multiplexer circuitry. In these implementations, the reconfigurable processing element may receive, with the first output register, the number of the first matrix from the first input port and route, with the third multiplexer circuitry, the sum from the adder circuit to the second output register in the weight stationary mode and the number of the second matrix from the second input port to the second output register in the output stationary mode based on the control signal.

For example, the reconfigurable processing element 600 of FIG. 6 may include output registers 671, 672 and multiplexer circuitry 684, and the reconfigurable processing element 600 may receive, with output register 672, the number of the first matrix from input port 631 and route, with multiplexer circuitry 684, the sum from the adder circuit 620 to output register 671 in the weight stationary mode and the number of the second matrix from input port 632 to output register 671 in the output stationary mode based on the control signal 690.

If desired, the reconfigurable processing element may include multiplexer circuitry coupled to the internal register, and route, with the multiplexer circuitry, the number of the second matrix from the second input port to the internal register in the weight stationary mode and the sum from the adder circuit to the internal register in the output stationary mode based on the control signal.

For example, the reconfigurable processing element 600 of FIG. 6 may include multiplexer circuitry 683 coupled to the internal register 670, and the reconfigurable processing element 600 may route, with the multiplexer circuitry 683, the number of the second matrix from input port 632 to the internal register 670 in the weight stationary mode and the sum from the adder circuit 620 to the internal register 670 in the output stationary mode based on the control signal 690.

Illustratively, the reconfigurable processing element may enable a write operation to the internal register for receiving the number of the second matrix in the weight stationary mode only during a load phase.

For example, the reconfigurable processing element may enable a write operation to the internal register 670 for receiving the number of the second matrix in the weight stationary mode only during a load phase. After the load phase, the internal registers of the reconfigurable processing elements of a systolic array may each store a different element of the second matrix, and the first matrix may be streamed into the systolic array for performing the matrix multiplication in the weight stationary mode.

In the output stationary mode, the internal registers of the reconfigurable processing elements of a systolic array may each store a different element of the result matrix, which may then be drained from the internal registers during a storage phase.

While the present technology is disclosed by reference to the preferred embodiments and examples detailed above, it is to be understood that these examples are intended in an illustrative rather than in a limiting sense. It is contemplated that modifications and combinations will readily occur to those skilled in the art, which modifications and combinations will be within the spirit of the invention and the scope of the following claims.

As will be appreciated by those of ordinary skill in the art, aspects of the presented technology may be embodied as a system, device, method, or computer program product apparatus. Accordingly, elements of the present disclosure may be implemented entirely in hardware, entirely in software (including firmware, resident software, micro-code, or the like) or in software and hardware that may all generally be referred to herein as a “apparatus,” “circuit,” “circuitry,” “module,” “computer,” “logic,” “FPGA,” “unit,” “system,” or other terms.

Furthermore, aspects of the presented technology may take the form of a computer program product embodied in one or more computer-readable medium(s) having computer program code stored thereon. The phrases “computer program code” and “instructions” both explicitly include configuration information for a CGRA, an FPGA, or other programmable logic as well as traditional binary computer instructions, and the term “processor” explicitly includes logic in a CGRA, an FPGA, or other programmable logic configured by the configuration information in addition to a traditional processing core. Furthermore, “executed” instructions explicitly includes electronic circuitry of a CGRA, an FPGA, or other programmable logic performing the functions for which they are configured by configuration information loaded from a storage medium as well as serial or parallel execution of instructions by a traditional processing core.

Any combination of one or more computer-readable storage medium(s) may be utilized. A computer-readable storage medium may be embodied as, for example, an electronic, magnetic, optical, electromagnetic, infrared, or semiconductor system, apparatus, or device, or other like storage devices known to those of ordinary skill in the art, or any suitable combination of computer-readable storage mediums described herein. In the context of this document, a computer-readable storage medium may be any tangible medium that can contain, or store, a program and/or data for use by or in connection with an instruction execution system, apparatus, or device. Even if the data in the computer-readable storage medium requires action to maintain the storage of data, such as in a traditional semiconductor-based dynamic random-access memory, the data storage in a computer-readable storage medium can be considered to be non-transitory.

A computer data transmission medium, such as a transmission line, a coaxial cable, a radio-frequency carrier, and the like, may also be able to store data, although any data storage in a data transmission medium can be said to be transitory storage. Nonetheless, a computer-readable storage medium, as the term is used herein, does not include a computer data transmission medium.

Computer program code for carrying out operations for aspects of the present technology may be written in any combination of one or more programming languages, including object-oriented programming languages such as Java, Python, C++, or the like, conventional procedural programming languages, such as the “C” programming language or similar programming languages, or low-level computer languages, such as assembly language or microcode. In addition, the computer program code may be written in VHDL, Verilog, or another hardware description language to generate configuration instructions for an FPGA, CGRA IC, or other programmable logic.

The computer program code if converted into an executable form and loaded onto a computer, FPGA, CGRA IC, or other programmable apparatus, produces a computer implemented method. The instructions which execute on the computer, FPGA, CGRA IC, or other programmable apparatus may provide the mechanism for implementing some or all of the functions/acts specified in the flowchart and/or block diagram block or blocks. In accordance with various implementations, the computer program code may execute entirely on the user's device, partly on the user's device and partly on a remote device, or entirely on the remote device, such as a cloud-based server. In the latter scenario, the remote device may be connected to the user's device through any type of network, including a local area network (LAN) or a wide area network (WAN), or the connection may be made to an external computer (for example, through the Internet using an Internet Service Provider). The computer program code stored in/on (i.e. embodied therewith) the non-transitory computer-readable medium produces an article of manufacture.

The computer program code, if executed by a processor, causes physical changes in the electronic devices of the processor which change the physical flow of electrons through the devices. This alters the connections between devices which changes the functionality of the circuit. For example, if two transistors in a processor are wired to perform a multiplexing operation under control of the computer program code, if a first computer instruction is executed, electrons from a first source flow through the first transistor to a destination, but if a different computer instruction is executed, electrons from the first source are blocked from reaching the destination, but electrons from a second source are allowed to flow through the second transistor to the destination. So, a processor programmed to perform a task is transformed from what the processor was before being programmed to perform that task, much like a physical plumbing system with different valves can be controlled to change the physical flow of a fluid.

Example 1 is a reconfigurable processing element for a systolic array that is configurable for multiplying a first matrix with a second matrix to determine a result matrix in a weight stationary mode or in an output stationary mode, comprising: first and second input ports; first and second multiplexer circuitry; an internal register; a multiplier circuit that generates a product of a number of the first matrix received from the first input port and a number of the second matrix received from the first multiplexer circuitry, wherein the first multiplexer circuitry routes the number of the second matrix from the internal register to the multiplier circuit in the weight stationary mode and from the second input port to the multiplier circuit in the output stationary mode based on a control signal; and an adder circuit that generates a sum of the product received from the multiplier circuit and a number of a partially determined element of the result matrix received from the second multiplexer circuitry, wherein the second multiplexer circuitry routes the number of the partially determined element of the result matrix from the second input port to the adder circuit in the weight stationary mode and from the internal register to the adder circuit in the output stationary mode based on the control signal.

In Example 2, the reconfigurable processing element of Example 1 further comprises an output port; and an output register coupled to the output port that receives the number of the first matrix from the first input port.

In Example 3, the reconfigurable processing element of Example 1 further comprises third multiplexer circuitry that provides as a selected signal the sum from the adder circuit in the weight stationary mode and the number of the second matrix from the second input port in the output stationary mode based on the control signal.

In Example 4, the reconfigurable processing element of Example 3 further comprises an output port; and an output register coupled to the output port that receives the selected signal from the third multiplexer circuitry.

In Example 5, the reconfigurable processing element of Example 1 further comprises third multiplexer circuitry coupled to the internal register that routes the number of the second matrix from the second input port to the internal register in the weight stationary mode and the sum from the adder circuit to the internal register in the output stationary mode based on the control signal.

In Example 6, the internal register of Example 5 further comprises a plurality of one-bit registers, and the number of the second matrix is stored in at most half of the plurality of one-bit registers in the weight stationary mode.

In Example 7, the internal register of Example 6 is enabled for receiving the number of the second matrix in the weight stationary mode only during a load phase.

In Example 8, the first input port of Example 1 has a first bit width and the second input port has a second bit width, and wherein the second bit width is at least twice as large as the first bit width.

In Example 9, the number of the second matrix of Example 8 uses the least significant bits of the second bit width.

In Example 10, the second multiplexer circuitry of Example 1 comprises at least twice as many two input multiplexers as the first multiplexer circuitry.

In Example 11, the reconfigurable processing element of Example 1 further comprises a configuration storage circuit that stores the control signal.

Example 12 is a systolic array for performing matrix multiplication of a first matrix and a second matrix to determine a result matrix, comprising: a plurality of reconfigurable processing elements that are configurable for operating in a weight stationary mode or in an output stationary mode, wherein each one of a first, second, third, fourth, and fifth reconfigurable processing element of the plurality of reconfigurable processing elements comprises: first and second input ports; first and second multiplexer circuitry; an internal register; a multiplier circuit; and an adder circuit, and wherein in the third reconfigurable processing element: the multiplier circuit generates a product of a number of the first matrix received from the first input port and a number of the second matrix received from the first multiplexer circuitry, wherein the first multiplexer circuitry routes the number of the second matrix from the internal register to the multiplier circuit in the weight stationary mode and from the second input to the multiplier circuit in the output stationary mode based on a control signal; and the adder circuit generates a sum of the product received from the multiplier circuit and a number of a partially determined element of the result matrix received from the second multiplexer circuitry, wherein the second multiplexer circuitry routes the number of the partially determined element of the result matrix from the second input port to the adder circuit in the weight stationary mode and from the internal register to the adder circuit in the output stationary mode based on the control signal.

In Example 13, each one of the first, second, third, fourth, and fifth reconfigurable processing element of Example 12 further comprises: first and second output ports; first and second output registers; and third multiplexer circuitry, and wherein in the third reconfigurable processing element: the first output register is coupled to the first output port and receives the number of the first matrix from the first input port; the second output register is coupled to the second output port; and the third multiplexer circuitry routes the sum from the adder circuit to the second output register in the weight stationary mode and the number of the second matrix from the second input port to the second output register in the output stationary mode based on the control signal.

In Example 14, the systolic array of Example 13 has: the first input port of the third reconfigurable processing element coupled to the first output port of the second reconfigurable processing element; the second input port of the third reconfigurable processing element coupled to the second output port of the first reconfigurable processing element; the first output port of the third reconfigurable processing element coupled to the first input port of the fourth reconfigurable processing element; and the second output port of the third reconfigurable processing element coupled to the second input port of the fifth reconfigurable processing element.

In Example 15, each one of the first, second, third, fourth, and fifth reconfigurable processing element of Example 12 further comprises: third multiplexer circuitry coupled to the internal register; and wherein in the third reconfigurable processing element: the third multiplexer circuitry routes the number of the second matrix from the second input port to the internal register in the weight stationary mode and the sum from the adder circuit to the internal register in the output stationary mode based on the control signal; and the internal register is enabled for receiving the number of the second matrix in the weight stationary mode only during a load phase.

In Example 16, in each one of the first, second, third, fourth, and fifth reconfigurable processing element of Example 12: the first input port has a first bit width and the second input port has a second bit width that is at least twice as large as the first bit width; and the second multiplexer circuitry comprises at least twice as many two input multiplexers as the first multiplexer circuitry.

Example 17 is a method of operating a reconfigurable processing element for a systolic array that is configured for performing matrix multiplication of a first matrix and a second matrix to determine a result matrix in a weight stationary mode or in an output stationary mode, wherein the reconfigurable processing element comprises first and second input ports, first and second multiplexer circuitry, an internal register, a multiplier circuit, and an adder circuit, comprising: with the first multiplexer circuitry, routing a number of the second matrix from the internal register to the multiplier circuit in the weight stationary mode and from the second input port to the multiplier circuit in the output stationary mode based on a control signal; with the multiplier circuit, generating a product of a number of the first matrix received from the first input port and the number of the second matrix received from the first multiplexer circuitry; with the second multiplexer circuitry, routing a number of a partially determined element of the result matrix from the second input port to the adder circuit in the weight stationary mode and from the internal register to the adder circuit in the output stationary mode based on the control signal; and with the adder circuit, generating a sum of the product received from the multiplier circuit and the number of the partially determined element of the result matrix received from the second multiplexer circuitry.

In Example 18, the reconfigurable processing element further comprises first and second output registers, and third multiplexer circuitry, and the method of Example 17 further comprises: with the first output register, receiving the number of the first matrix from the first input port; and with the third multiplexer circuitry, routing the sum from the adder circuit to the second output register in the weight stationary mode and the number of the second matrix from the second input port to the second output register in the output stationary mode based on the control signal.

In Example 19, the reconfigurable processing element further comprises third multiplexer circuitry coupled to the internal register, and the method of Example 17 further comprises: with the third multiplexer circuitry, routing the number of the second matrix from the second input port to the internal register in the weight stationary mode and the sum from the adder circuit to the internal register in the output stationary mode based on the control signal.

In Example 20, the method of Example 19 further comprises: enabling a write operation to the internal register for receiving the number of the second matrix in the weight stationary mode only during a load phase.

What is claimed is:

1. A reconfigurable processing element for a systolic array that is configurable for multiplying a first matrix with a second matrix to determine a result matrix in a weight stationary mode or in an output stationary mode, comprising:
first and second input ports;
first and second multiplexer circuitry;
an internal register;
a multiplier circuit that generates a product of a number of the first matrix received from the first input port and a number of the second matrix received from the first multiplexer circuitry, wherein the first multiplexer circuitry routes the number of the second matrix from the internal register to the multiplier circuit in the weight stationary mode and from the second input port to the multiplier circuit in the output stationary mode based on a control signal; and
an adder circuit that generates a sum of the product received from the multiplier circuit and a number of a partially determined element of the result matrix received from the second multiplexer circuitry, wherein the second multiplexer circuitry routes the number of the partially determined element of the result matrix from the second input port to the adder circuit in the weight stationary mode and from the internal register to the adder circuit in the output stationary mode based on the control signal.

2. The reconfigurable processing element of claim 1, further comprising:
an output port; and
an output register coupled to the output port that receives the number of the first matrix from the first input port.

3. The reconfigurable processing element of claim 1, further comprising:
third multiplexer circuitry that provides as a selected signal the sum from the adder circuit in the weight stationary mode and the number of the second matrix from the second input port in the output stationary mode based on the control signal.

4. The reconfigurable processing element of claim 3, further comprising:
an output port; and
an output register coupled to the output port that receives the selected signal from the third multiplexer circuitry.

5. The reconfigurable processing element of claim 1, further comprising:
third multiplexer circuitry coupled to the internal register that routes the number of the second matrix from the second input port to the internal register in the weight stationary mode and the sum from the adder circuit to the internal register in the output stationary mode based on the control signal.

6. The reconfigurable processing element of claim 5, wherein the internal register comprises a plurality of one-bit registers, and wherein the number of the second matrix is stored in at most half of the plurality of one-bit registers in the weight stationary mode.

7. The reconfigurable processing element of claim 6, wherein the internal register is enabled for receiving the number of the second matrix in the weight stationary mode only during a load phase.

8. The reconfigurable processing element of claim 1, wherein the first input port has a first bit width and the second input port has a second bit width, and wherein the second bit width is at least twice as large as the first bit width.

9. The reconfigurable processing element of claim 8, wherein the number of the second matrix uses the least significant bits of the second bit width.

10. The reconfigurable processing element of claim 1, wherein the second multiplexer circuitry comprises at least twice as many two input multiplexers as the first multiplexer circuitry.

11. The reconfigurable processing element of claim 1, further comprising:
a configuration storage circuit that stores the control signal.

12. A systolic array for performing matrix multiplication of a first matrix and a second matrix to determine a result matrix, comprising:
a plurality of reconfigurable processing elements that are configurable for operating in a weight stationary mode or in an output stationary mode, wherein each one of a first, second, third, fourth, and fifth reconfigurable processing element of the plurality of reconfigurable processing elements comprises:
first and second input ports;
first and second multiplexer circuitry;
an internal register;
a multiplier circuit; and
an adder circuit, and wherein in the third reconfigurable processing element:
the multiplier circuit generates a product of a number of the first matrix received from the first input port and a number of the second matrix received from the first multiplexer circuitry, wherein the first multiplexer circuitry routes the number of the second matrix from the internal register to the multiplier circuit in the weight stationary mode and from the second input to the multiplier circuit in the output stationary mode based on a control signal; and
the adder circuit generates a sum of the product received from the multiplier circuit and a number of a partially determined element of the result matrix received from the second multiplexer circuitry, wherein the second multiplexer circuitry routes the number of the partially determined element of the result matrix from the second input port to the adder circuit in the weight stationary mode and from the internal register to the adder circuit in the output stationary mode based on the control signal.

13. The systolic array of claim 12, wherein each one of the first, second, third, fourth, and fifth reconfigurable processing element further comprises:
first and second output ports;
first and second output registers; and
third multiplexer circuitry, and wherein in the third reconfigurable processing element:
the first output register is coupled to the first output port and receives the number of the first matrix from the first input port;
the second output register is coupled to the second output port; and
the third multiplexer circuitry routes the sum from the adder circuit to the second output register in the weight stationary mode and the number of the second matrix from the second input port to the second output register in the output stationary mode based on the control signal.

14. The systolic array of claim 13, wherein:
the first input port of the third reconfigurable processing element is coupled to the first output port of the second reconfigurable processing element;
the second input port of the third reconfigurable processing element is coupled to the second output port of the first reconfigurable processing element;
the first output port of the third reconfigurable processing element is coupled to the first input port of the fourth reconfigurable processing element; and
the second output port of the third reconfigurable processing element is coupled to the second input port of the fifth reconfigurable processing element.

15. The systolic array of claim 12, wherein each one of the first, second, third, fourth, and fifth reconfigurable processing element further comprises:
third multiplexer circuitry coupled to the internal register; and wherein in the third reconfigurable processing element:
the third multiplexer circuitry routes the number of the second matrix from the second input port to the internal register in the weight stationary mode and the sum from the adder circuit to the internal register in the output stationary mode based on the control signal; and
the internal register is enabled for receiving the number of the second matrix in the weight stationary mode only during a load phase.

16. The systolic array of claim 12, wherein in each one of the first, second, third, fourth, and fifth reconfigurable processing element:
the first input port has a first bit width and the second input port has a second bit width that is at least twice as large as the first bit width; and
the second multiplexer circuitry comprises at least twice as many two input multiplexers as the first multiplexer circuitry.

17. A method of operating a reconfigurable processing element for a systolic array that is configured for performing matrix multiplication of a first matrix and a second matrix to determine a result matrix in a weight stationary mode or in an output stationary mode, wherein the reconfigurable processing element comprises first and second input ports, first and second multiplexer circuitry, an internal register, a multiplier circuit, and an adder circuit, comprising:
with the first multiplexer circuitry, routing a number of the second matrix from the internal register to the multiplier circuit in the weight stationary mode and from the second input port to the multiplier circuit in the output stationary mode based on a control signal;
with the multiplier circuit, generating a product of a number of the first matrix received from the first input port and the number of the second matrix received from the first multiplexer circuitry;
with the second multiplexer circuitry, routing a number of a partially determined element of the result matrix from the second input port to the adder circuit in the weight stationary mode and from the internal register to the adder circuit in the output stationary mode based on the control signal; and
with the adder circuit, generating a sum of the product received from the multiplier circuit and the number of the partially determined element of the result matrix received from the second multiplexer circuitry.

18. The method of claim 17, wherein the reconfigurable processing element further comprises first and second output registers, and third multiplexer circuitry, further comprising:
with the first output register, receiving the number of the first matrix from the first input port; and
with the third multiplexer circuitry, routing the sum from the adder circuit to the second output register in the weight stationary mode and the number of the second matrix from the second input port to the second output register in the output stationary mode based on the control signal.

19. The method of claim 17, wherein the reconfigurable processing element further comprises third multiplexer circuitry coupled to the internal register, further comprising:
with the third multiplexer circuitry, routing the number of the second matrix from the second input port to the internal register in the weight stationary mode and the sum from the adder circuit to the internal register in the output stationary mode based on the control signal.

20. The method of claim 19, further comprising:
enabling a write operation to the internal register for receiving the number of the second matrix in the weight stationary mode only during a load phase.
